(19) United States
(12) Patent Application Publication
(10) Pub. No.: US 2013/0297689 A1
(43) Pub. Date: Nov. 7, 2013

(54) Activity Stream Tuning Using Multichannel Communication Analysis

(71) Applicants: Raghurama Bhat, Cupertino, CA (US); Biren Gandhi, San Jose, CA (US); Keith Griffin, Galway (IE)

(72) Inventors: Raghurama Bhat, Cupertino, CA (US); Biren Gandhi, San Jose, CA (US); Keith Griffin, Galway (IE)

(73) Assignee: CISCO TECHNOLOGY, INC., San Jose, CA (US)

(21) Appl. No.: 13/463,227

(22) Filed: May 3, 2012

(51) Int. Cl. G06F 15/16

(52) U.S. Cl. 709/204

(57) ABSTRACT

A social graph is constructed to be representative of a social network by including nodes and edges representing activities in the social network. Activities in communication transactions of a communication network are identified and activity stream tuning parameters are determined for a user of the social network from the identified relationships. Activity stream data is presented to the user in accordance with the tuning parameters.

### TECHNICAL FIELD

The present disclosure relates activity stream data tuning in social networks.

### BACKGROUND

Social networks typically implement an activity stream whereby an end user is notified of activities happening in one's social network. Activity streams are formed from data representing a combination of real-time and non-real-time events. The volume of information contained in activity streams depends on the number of people in one's network, the number of one's group associations and the activity level thereof, and the strength of one's connections. This volume grows exponentially with the size of user's social connectivity and, consequently, finding useful or relevant information in a user's activity stream can be problematic. As a result, users are discouraged from participating in social network expansion activities.

Enterprise Social Networking Systems have tremendous access to end user communications happening outside of a social network platform as they can monitor and leverage almost all electronic communications such as, for example, corporate email, Instant Messaging, voice calls, video and web conferences, and shared calendars. Such communications can all be tracked to enhance activity streams, but with such enhancements is a substantial increase in the volume of information.

### BRIEF DESCRIPTION OF THE DRAWINGS

FIG. 1 is a functional block diagram a social network configured to perform the activity stream tuning techniques described herein.

FIGS. 2A-2B are block diagrams of example interacting communication system components by which multichannel analysis and activity stream tuning is achieved.

FIGS. 3A-3C are diagrams of example graphs in accordance with which activity stream data are stored and analyzed.

FIG. 4 is a functional block diagram of an example process by which multichannel analysis and activity stream tuning is achieved.

### DESCRIPTION OF EXAMPLE EMBODIMENTS

### Overview

A social graph is constructed to be representative of a social network by including nodes and edges representing activities in the social network. Activities in communication transactions of a communication network are identified and activity stream tuning parameters are determined for a user of the social network from the identified relationships. Activity stream data is presented to the user in accordance with the tuning parameters.

### Example Embodiments

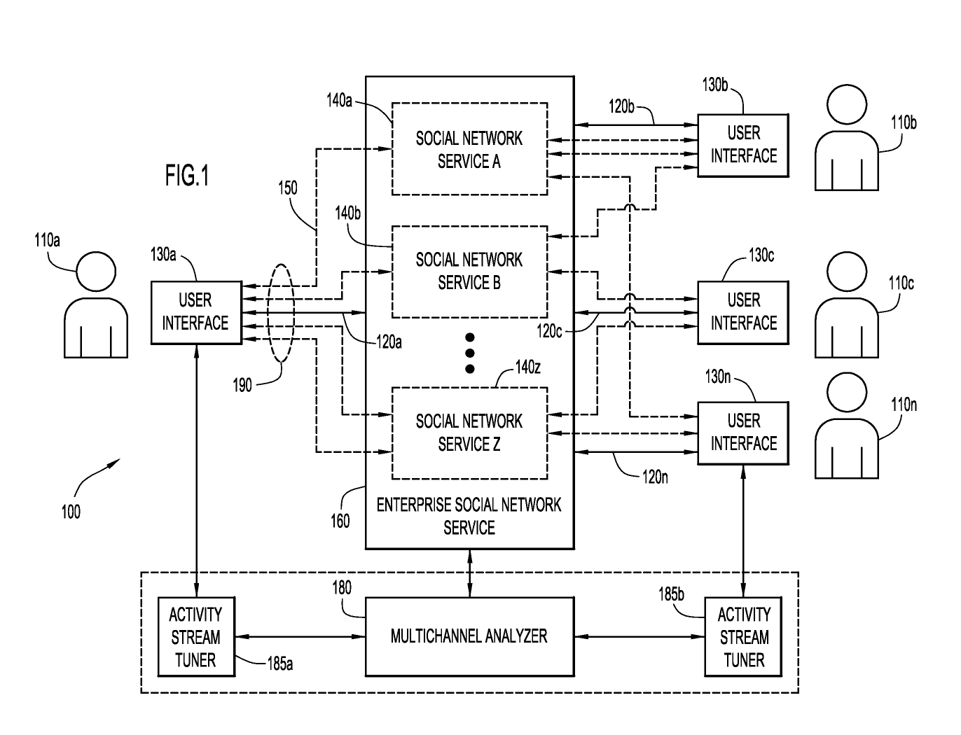

An example social network 100 is illustrated in FIG. 1 wherein various users 110a-110n, representatively referred to herein as user 110, interact through communication channels 120a-120n, representatively referred to as communication channels 120, formed in a communication network. It is to be understood that while only individual channels are illustrated at each user 110a-110n, users may communicate through multiple, concurrently active communication channels, as will be recognized by the ordinarily skilled artisan upon review of this disclosure. Facilitating the aforementioned interactions are user interfaces 130a-130n, representatively referred to as user interfaces 130, which afford user interaction with social network 100, and convert and/or format human intelligible user content into data that can be transported over a communication network, and vice-versa. Speech, text, static images, video, symbols, music are examples of content, but the techniques disclosed herein are not limited to content type and such content may be conveyed as audio and/or video data, email, telephone conversations, documents, image files, social network interaction data such as postings and content ratings, calendar data, instant messaging, presence service data, and other such information-carrying data types. The data may be conveyed in communication channels 120 suitably constructed in the communication network.

Social network 100 may include one or more social networking services 140a-140z, which distribute the user content among social network members subscribing thereto. Social network channels, illustrated by the dashed paths in FIG. 1 and representatively referred to as social network channels 150, convey data formatted in compliance with social network services 140 over communication channels 120. The content carried in social network channels 150 contribute to form activity streams 190 for respective users 110. An activity stream may be presented to a particular user in accordance with filtering/tuning parameters applied by activity stream tuners 185a-185b, representatively referred to herein as activity stream tuners 185. For example, activity stream tuners 185 may order the activities in an activity stream in accordance with tuning parameters that, for example, assign a presentation priority defined by relevance of content to the user's own activities.

As illustrated in FIG. 1, social network services 140 may be executed as processes of an enterprise social network service 160. When so embodied, communications other than those that are typically associated with social networks can be leveraged and monitored to enhance the activity tuning, as will be described in the paragraphs that follow. To that end, multichannel analyzer 180 may formulate tuning parameters from social network activities and from activities of users communicating through communication channels 120 but outside social network channels 150.

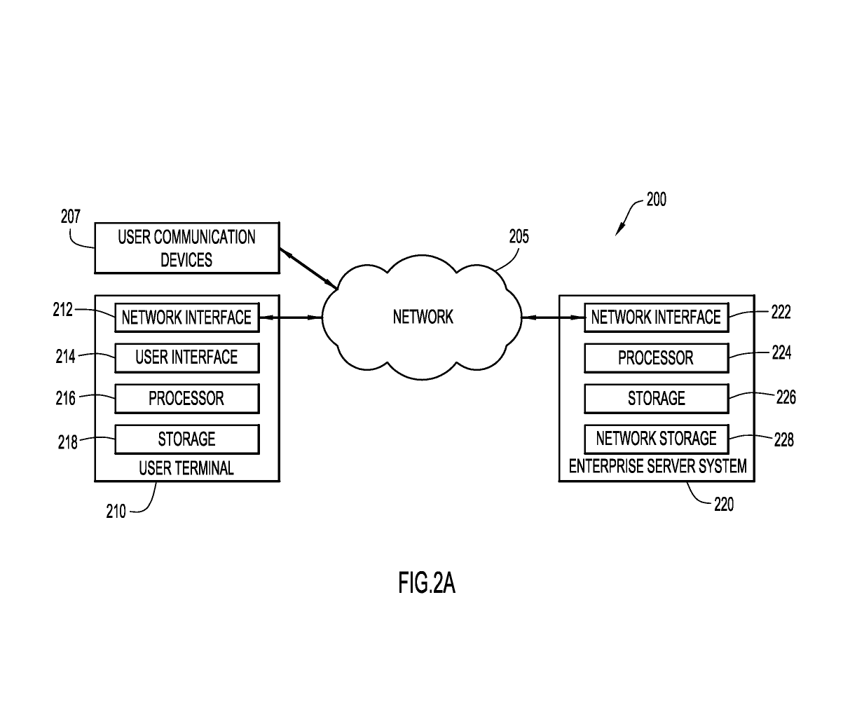

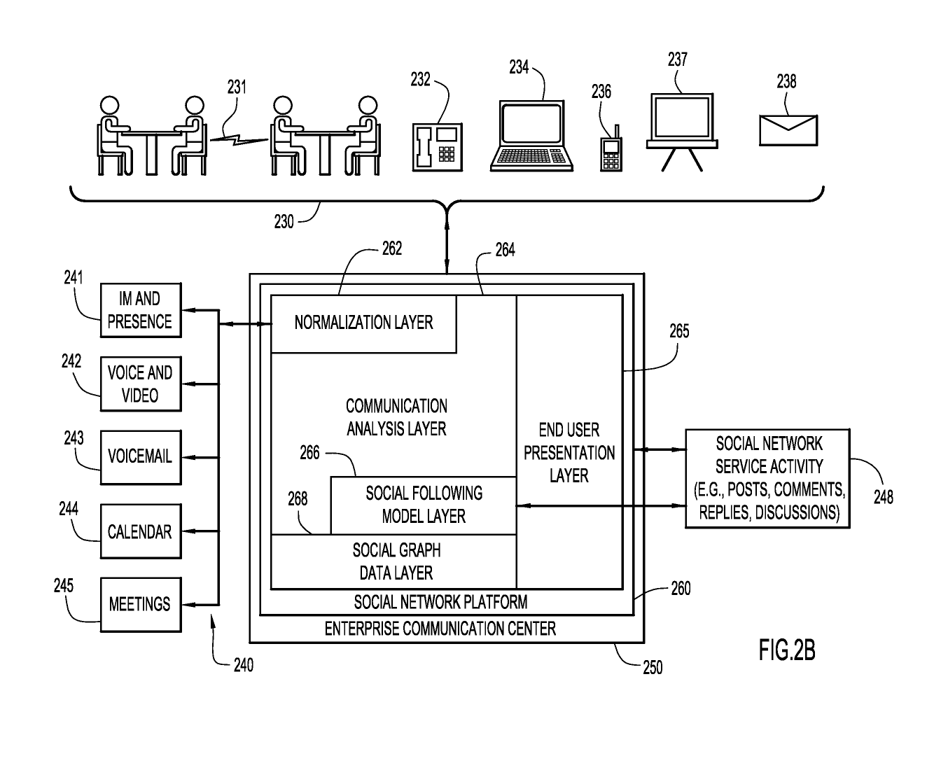

In FIG. 2, an example of a communication system 200 is illustrated by which communications between user communication devices 207, user terminals 210 and enterprise server system 220 communicate over communications network 205. User terminal 210 and server system 220 may include network interfaces 212 and 222, respectively, which implement the electronic/digital circuitry to communicate using specific physical layer and data link layer standards, e.g., Ethernet, Wi-Fi™, etc., and processing resources to implement a network protocol stack, such as for the Internet Protocol (IP). User communication devices 207, which may include telephones, audio-visual equipment, etc., may include similar network interface circuitry. Indeed, any of network interfaces 212, 222 and communication devices 207 may include circuitry to accommodate other communication formats such as, for example, Voice-over IP (VoIP) and H.323.

User terminal 210 and server system 220 may include processor systems 216 and 226, respectively, each including one or more cooperating computer processors. Processor systems 216 and 226 may be communicatively coupled to storage units 218 and 228, respectively, to store data and processor instructions that, when executed by respective processors 216 and 226, data processing operations are performed by which the disclosed techniques may be implemented. User interface 214 may include a display and Human Interface Devices (HIDs) by which a user at a corresponding user terminal 210 interacts with other components of network 200. Server system 220 may include a network storage system 228 to store data on behalf of users and user devices on network 205.

The system components illustrated in FIG. 2A may be configured to implement the functionality illustrated in FIG. 2B. Enterprise communication center 250 may execute on processor system 224 as part of enterprise server system 220. Enterprise communication center 250 may realize a central hub through which all electronic communications are conveyed between parties of an enterprise. Sources 230 of such communications may include, to name but a few, audio-visual (A/V) teleconferences, representatively illustrated at A/V teleconference 231, telephone communications, representatively illustrated at telephone 232, computer communications such as email, web browsing, etc., representatively illustrated by computer 234, mobile communications, representatively illustrated at cellular phone 236, other A/V communications, representatively illustrated at presentation device 237 and email messages 238. Additional sources of content provided to enterprise communication center 250 include instant messaging and presence services 241, voice and video services 242, voicemail services 243, shared calendar services 244 and meeting services 245. The ordinarily skilled artisan will recognize other communication inputs upon review of this disclosure. The disclosed technique is not limited by communication technology; such will vary by application as will be readily recognized and appreciated by the ordinarily skilled artisan.

In certain embodiments, enterprise communication center 250 maintains transaction records that contain detailed information regarding each event from input sources 230. The transaction records may be constructed from information obtained through Application Programming Interfaces (APIs) on systems associated with the various sources. For example, a telecommunication system API may produce call detail records for voice and video calls, web meeting services may provide suitable APIs to obtain meeting events and details, email servers may provide an Internet Message Access Protocol (IMAP) API, etc. Such transaction records may contain, among other things, participant identification, communication duration, captured text/audio/video, etc. For example, in the case of an email, the transaction record may contain details regarding, among other things, the sender, recipients, subject, body, and attachments. For a telephone call, the transaction record may contain details regarding, among other things, the caller, callee, call duration, terminal endpoints and, in certain cases, a recording of the conversation. The amount of detail in the transaction records may vary by application and the information stored in the transaction records may be included as input to the analyses described below.

Enterprise communication center 250 may include a social network platform 260 by which activity streams are processed and conveyed. Social network platform 260 may be viewed in terms of operational layers: a normalization layer 263, a communication analysis layer 264, a social graph/unstructured data layer 268, a social following model layer 268 and an end-user presentation layer 265. It is to be understood that such layering of social network platform 260 represents an abstraction of different collections of processes solely for purposes of description and not by way of limitation.

Normalization layer 263 is not necessary to the technique, but may reduce the content in communications 230, social network channel content 240 and transaction records thereof into a common format, such as eXtensible Markup Language (XML) format, to simplify the analyses that follow. Normalization layer 262 may enhance the resulting formatted data, or analysis data, with additional information found in other sources. For example, certain analysis data items may be used in a database query to gather additional information, e.g., an email address from a provided telephone number, or vice-versa.

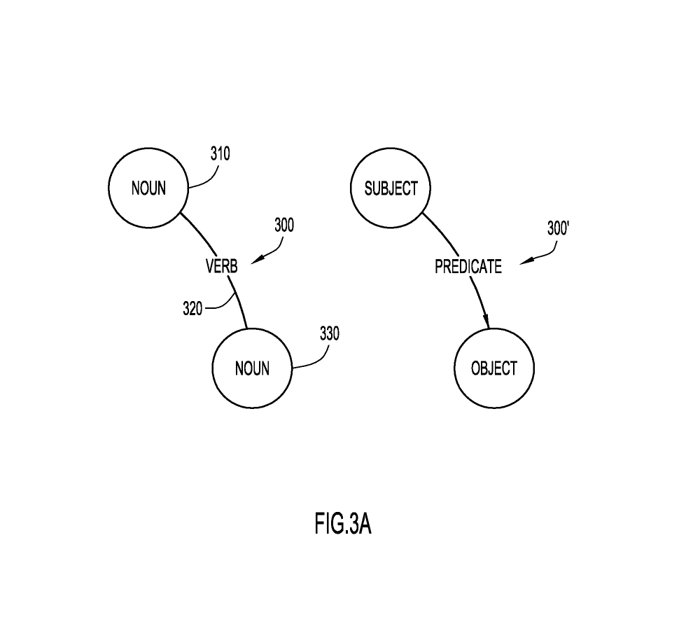

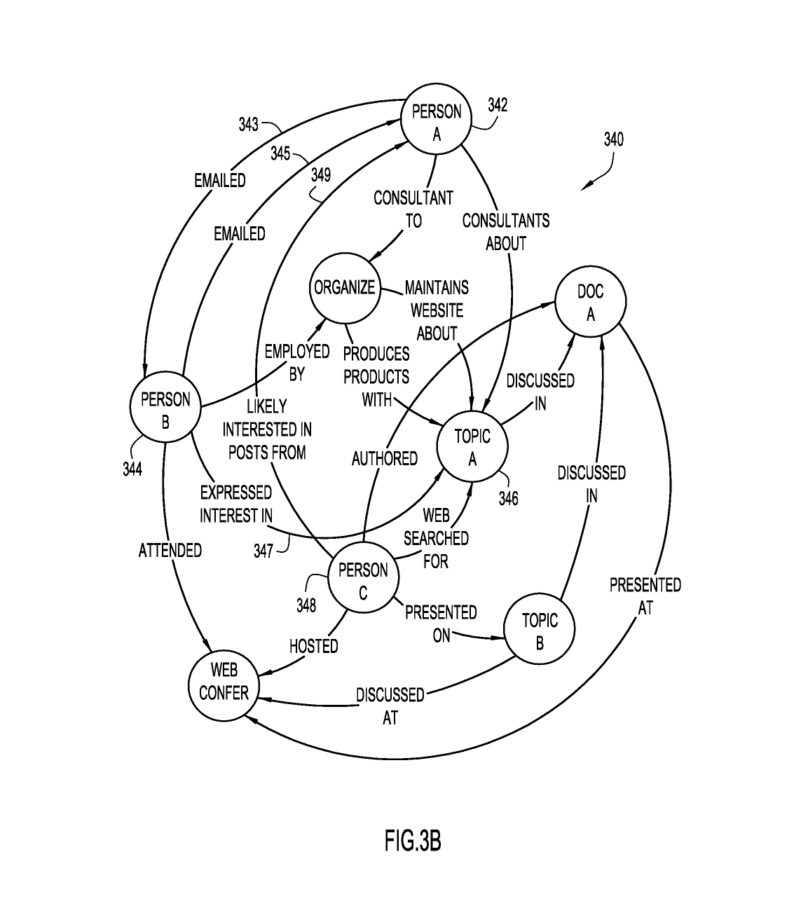

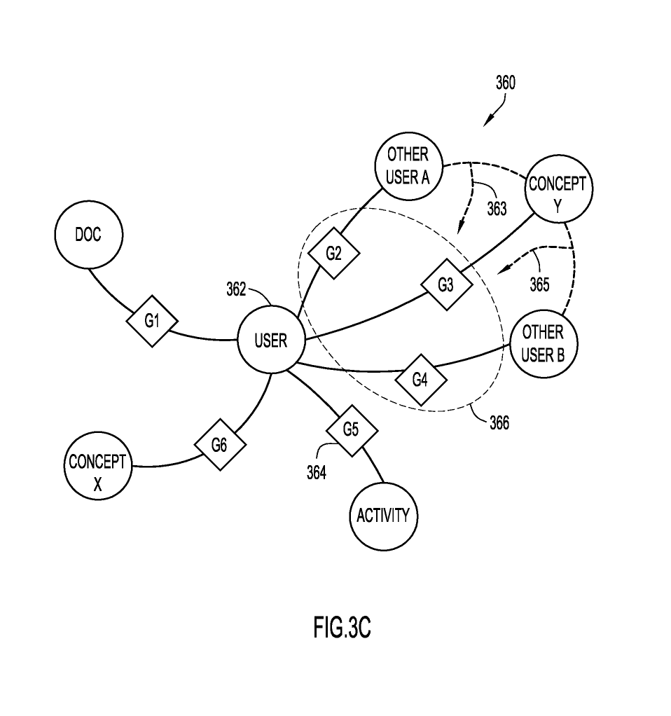

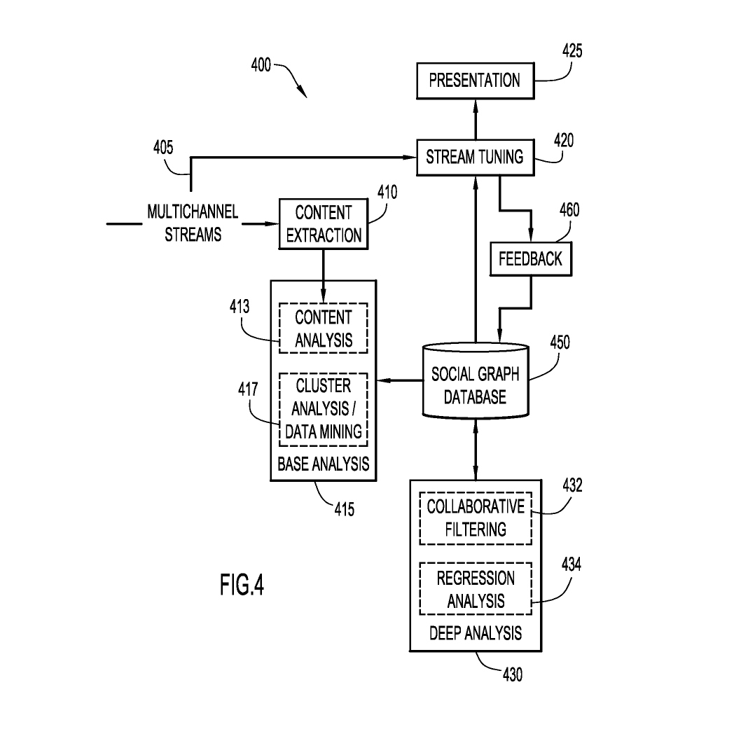

Communication analysis layer 264 implements computational and data processing resources to perform content analysis on the analysis data. Example processes by which such analysis is achieved is described in detail below with reference to FIG. 4. Briefly, communication analysis layer categorizes/classifies communication events to produce therefrom a data structure referred to herein as a social graph. For example, communication analysis layer 264 may evaluate the content associated with the events and generate therefrom semantic relationships, representatively illustrated in FIG. 3A. FIG. 3A illustrates a relationship in the form of a graph 300, which is representatively illustrated by two (2) nodes 310 and 330 connected by an edge or connector 320. The semantic relationship of graph 300 is in the form of a noun-verb-noun data structure and, alternatively may be in the form of a subject-predicate-object structure illustrated by graph 300′. A semantic relationship may thus take the form, “Bob (noun/subject) emailed (verb/predicate) Alice (noun/object),” although other data constructs may be used in conjunction with the disclosed concept. Communication analysis layer 264 performs processes by which graphs 300 are formed and refined. To do so, analysis may include consulting knowledge- and/or dictionary-based databases that can recognize and classify different words. Natural language analysis and semantic content analysis may also be applied. Word and phrase frequency may be used to infer relevance and importance of the content. Cluster analysis may be performed to determine topics, expertise, interests, roles of different participants in a conversation or meeting, and so on. Numerous different content analysis routines can be used in conjunction with the techniques described herein.

Communication analysis layer 264 constructs and updates a social graph formed from such semantic relationships across a wide array of entities, e.g., individuals, organizations, topics, etc. An example social graph is illustrated as social graph 340 in FIG. 3B. It is to be understood that a social graph, when describing numerous users, different activities of those users, topics, communication channels, social network channels, etc., may be extensive and complex. Social graph 340 may also be extensible, allowing expansion as users, communication channels, social network services, and so on, are added. Social graph 340 is thus merely an example of a potentially much larger data structure, the full breadth of possible configurations of which will be understood and appreciated by the ordinarily skilled artisan without an element-by-element description of each node and edge illustrated in FIG. 3B. However, select components of social graph 340 are described below.

As illustrated in FIG. 3B, nodes of social graph 340 may represent various entities that interact or are acted upon, such as persons, organizations, meetings, topics, shared content, essentially without limit. In early stages of its construction, i.e., in initial analysis passes of communication analysis layer 264, simple relationships may be identified and stored in social graph 340. For example, the relationships formed by nodes 342 and 344, and edges 343 and 345 represent or indicate that Persons A and B simply emailed one another. As additional processing is performed, deeper relationships may emerge. For example, the relationship comprising nodes 344, 346 and edge 347 represent that Person B has an expressed interest in Topic A. Such a relationship may be determined from actual content in a message, i.e., “I have an interest in Topic A,” or may be inferred from other analyses, such as, for example, by the frequency of requests for information surrounding Topic A, including by, for example, web searches. Still further analysis may reveal other relationships. For example, the relationship represented by nodes 348, 342 and edge 349 represent that Person C would likely be interested in posts from Person A. Such interest may be inferred from the apparent expertise of Person A on Topic A, i.e., Person A is a consultant on Topic A, is a consultant to an organization which produces products with Topic A, and so on. In still another example, Person C has conducted a web search on Topic A and has authored Document A in which Topic A is discussed. Clustering analysis, regression analysis, collaborative filtering, and other techniques applied to social graph 340 may indicate that, accordingly, Person C would likely be interested in contributions submitted by Person A, based on the foregoing example relationships.

Social graph 340 may be maintained in social graph data layer 268 illustrated in FIG. 2B, where it can be accessed and refined by other layers of social networking platform 260. Social graph data layer 268 may contain unstructured information as well, such as communication events, community and information interactions. In certain embodiments, social graph data layer 268 and/or the associations represented therein may be accessed and/or delivered to other systems, both internal and external to enterprise communication center 250, so that user interactions transpiring over other channels can be similarly tuned.

Social following model layer 266 forms user-specific social graph information by which activity streams are tailored to a specific user, as illustrated by user graph 360 in FIG. 3C. User graph 360 represents the associations and/or interactions of the particular user represented by node 362 with other entities using a bi-directional following model. Entities that can be followed include, without being limited to: people/other users; information: tags/concepts; community activity, and so on. It is to be understood that user graph 360 need not be constructed separately from social graph 340; illustration of such by user graph 360 is for purposes of explanation only. Generally, a user graph contains data by which activities associated with a particular user can be identified and tracked for purposes of activity stream tuning.

Edges of user graph 360 may be weighted, representatively illustrated at weight 364, where the weighting is based on, for example, frequency, duration, timing and quality of interactions in the follow-model. Values assigned to weights 364 can be used both positively to prioritize related activities and negatively to de-prioritize related activities displayed to an end user. As illustrated in FIG. 3C, interactions between or pertaining to other entities determined by communication analysis layer 264, representatively illustrated at arrows 363, 365, can influence the weighting of certain edges, representatively illustrated at edges 366. It is to be understood that the weights 364 are associated with a particular user 362; each user has a set of weights 364 associated therewith, which may be determined by social following model layer 266 and stored in social graph data layer 268. Following the interactions represented in social graph 340 and weighting corresponding edges in user graph 360 can be used to enrich the user 362 activity feed with highly relevant information: following a document because it was shared in a meeting; following a concept/tag because the user mentioned it numerous times in a meeting; following a concept/tag based on their occurrences in email, voice mail and IM conversations; following a person based on frequency, duration and quality of interactions with an individual; following a community based on frequency, duration and quality of interactions with a group of individuals. Additionally, following communication interactions can be used to filter down (reduce) the amount of information presented in user's activity stream: lack of interactions with a person or group of people in terms of frequency, duration and quality; based on a user joining, actively participating during and after a meeting (e.g., the user has seen enough); non-active engagement with a community (e.g., not replying to emails, not clicking on links in those emails, not joining meetings, not participating in IM/Voice/Email conversations with any of the members) and so on.

Referring back to FIG. 2B, as activity events occur, either in response to incoming data from sources 230, sources 240 or from user-input social network activity 248, the events are processed by the layers of social networking platform 260 and formatted into a presentable activity stream through end user presentation layer 265. End user presentation layer 265 may implement a user interface by which user input on the activity stream is recognized, processed and optionally passed to other layers of social networking platform 260.

An example activity stream tuning process 400 is illustrated in FIG. 4. In operation 410, content is extracted from multichannel streams 405, which comprise both social network channel data and communication data outside social networking services. Content extraction process 410 identifies substantive information carried in the multichannel streams and performs any data conversions necessary to afford subsequent processing. Additionally, content extraction process 410 may convert the information carried in the multichannel streams into a common data format.

Extracted content may be provided to base analysis process 415, by which initial processing is performed to construct and/or update a social graph representing the activities conducted in the social network. The social graph constructed and/or updated by base analysis process 415 may be stored in social graph database 450. As illustrated in FIG. 4, content analysis process 413 may be performed to identify semantic relationships carried in the extracted content. For example, natural language analysis may be used to identify phrases having noun-verb-noun or subject-predicate-object construction and make node and edge assignments in the social graph accordingly. Additionally, content analysis process 413 may identify data fields designated to carry specific information and make node and edge assignments from the content of the identified fields.

Base analysis process 415 may include cluster analysis/data mining process 417 to enhance the social graph with, for example, additional edges between nodes that indicate activity patterns and weighting of edges associated with activities of a particular user. For example, cluster analysis may reveal that multiple conversations in which the same topic was discussed occurred between the same group of people. Accordingly, edges between the nodes representing such people may be formed and weighted so as to indicate an interest in the topic.

Deep analysis process 430 may further enhance the social graph by performing processes that use greater computational resources than that of base analysis process 415. Thus, execution of deep analysis process 430 may be deferred until the necessary resources are available. As illustrated in FIG. 4, deep analysis process 430 may include collaborative filtering process 432 to make inferences regarding a particular user's interests based on the interests expressed or inferred from others represented in the social graph. For example, collaborative filtering process 432 may determine from relationships gathered from the social graph and the interests of the user already determined which of those relationships are similar to those interests. Collaborative filtering process 432 may insert edges in the social graph that indicate such inferred interests and/or modify user graph weights accordingly. Deep analysis process 430 may further include regression analysis process 434 by which inferences can be made with regard to the user's current interests from linear and/or non-linear regression techniques.

Stream tuning process 420 consults the user/social graph to determine relevance to a particular user of activities represented therein. Such relevance may be indicated to in activity stream tuning parameters that are tracked for a particular user. Stream tuning process 420 may, for example, evaluate new edges formed in the social graph that share nodes representing activity the particular user is already following, evaluate user-specific weights on edges representing user activities, interests, etc., evaluate statistical data generated from analysis of the social graph, evaluate collaborative filtering data, etc., to determine directly or by inference relevance to the user's interests. Stream tuning process 420 may add and/or delete followed activities in the activity stream, and may order presentation of followed activities according to current relevance to the user. Stream tuning process may assign presentation priority weights that indicate the order in which events in the activity stream are to be presented to the user. The tuned activity stream is provided to presentation process 425, by which the activity stream is presented to the user in accordance with that user's tuning parameters.

Activity tuning process 400 may include a feedback process 460 to adjust the user's tuning parameters in accordance with actions taken by the user on the activity stream in the presentation layer. For example, an event may be presented in the user's activity stream and the user may dismiss the event as being uninteresting or irrelevant. Feedback process 460 may insert an edge between the appropriate nodes to indicate to the analysis processes 415 and 430 that the particular user has expressly dismissed the event and/or may modify user-specific edge weights accordingly. Analysis processes 415 and 430 may note the added or weighted edge in the social graph and avoid computing unnecessary recommendation data based on the user's expressed dismissal. It is to be understood that positive feedback, such as by the user's expressed appreciation of an event, may be used in an analogous manner.

It is to be understood that only a few examples of modifying the social graph in response to activity stream tuning process 400 have been described herein. The ordinarily skilled artisan will recognize and appreciate the extensive breadth of possible processing, social graph manipulation and activity stream tuning in light of these examples once this disclosure has been reviewed.

Referring once again to FIGS. 2A and 2B, storage unit 226 may comprise read only memory (ROM), random access memory (RAM), magnetic disk storage media devices, optical storage media devices, flash memory devices, electrical, optical, or other physical/tangible memory storage devices. Processor 224 is, for example, a microprocessor or microcontroller that executes instructions for the social network platform logic. Thus, in general, the memory 226 may comprise one or more tangible (non-transitory) computer readable storage media (e.g., a memory device) encoded with software comprising computer executable instructions and when the software is executed (by the processor 224) it is operable to perform the operations described herein in connection with content extraction logic 410, base analysis logic 415, deep analysis logic 430, stream tuning logic 420, feedback logic 460, presentation logic 425 and/or database logic 450.

The above description is intended by way of example only.

What is claimed is:

1. A method comprising:
constructing a social graph representative of a social network, the social graph including nodes and edges representing activities in the social network;
extracting content from communication transactions of a communication network;
modifying the social graph in accordance with the extracted content;
determining activity stream tuning parameters for a user of the social network from the modified social graph; and
presenting activity stream data to the user in accordance with the tuning parameters.

2. The method of claim 1, wherein modifying the social graph includes:
identifying relationships between the activities conducted through a social network service and other activities determined from the extracted content of the communication transactions outside the social network service;
representing the other activities in the social graph; and
storing data representing the social graph.

3. The method of claim 2, wherein representing the activities includes:
identifying semantic elements in the extracted content;
assigning the identified semantic elements to additional nodes and edges in the social graph; and
adding the additional nodes and edges to the social graph.

4. The method of claim 3, wherein the semantic elements are of noun-verb-noun form identifying at least participants in the respective communication transactions as a noun.

5. The method of claim 3, wherein determining activity stream tuning parameters includes:
identifying nodes connected to a node in the social graph representing the user;
establishing weights on respective edges connecting the nodes to the user node; and
assigning values to the weights based on a quality of the respective activities represented by the edges.

6. The method of claim 5, further comprising:
monitoring the activities to determine a frequency, duration or timing of an activity represented by a corresponding one of the weighted edges connected to the user node; and
updating the values of the weights in accordance with a change in the frequency, the duration or the timing.

7. The method of claim 6, further comprising:
performing background analysis on the clustered nodes, the background analysis being performed independently of the monitoring; and
modifying the values assigned to the weights in accordance with the background analysis.

8. The method of claim 7, wherein the background analysis includes at least one of collaborative filtering and regression analysis.

9. The method of claim 8, wherein modifying the tuning parameters includes:
determining a relevance score from the weights; and
assigning a presentation priority to the tuning parameters in accordance with the relevance score.

10. The method of claim 9, further comprising:
decreasing the relevance score upon a determination of a reduction in one or more values of the weights.

11. An apparatus comprising:
a network interface through which communication transactions occur over a communication network;
a memory in which to store a social graph representative of a social network, the social graph including nodes and edges representing activities in the social network;
a processor configured to:
extract content from the communication transactions;
modify the social graph in accordance with the extracted content; and
determine activity stream tuning parameters for a user of the social network from the modified social graph; and
a user interface to present activity stream data to the user in accordance with the tuning parameters.

12. The apparatus of claim 11, wherein the processor is configured to:
identify relationships between the activities conducted through a social network service and other activities determined from the extracted content of the communication transactions outside the social network service;
represent the other activities in the social graph; and
store data representing the social graph.

13. The apparatus of claim 12, wherein the processor is configured to:
identify semantic elements in the extracted content;
assign the identified semantic elements to additional nodes and edges in the social graph; and
add the additional nodes and edges to the social graph.

14. The apparatus of claim 13, wherein the processor is configured to:
identify nodes connected to a node in the social graph representing the user;
establish weights on respective edges connecting the nodes to the user node; and
assign values to the weights based on a quality of the respective activities represented by the edges.

15. The apparatus of claim 14, wherein the processor is configured to:
monitor the activities to determine a frequency, duration or timing of an activity represented by a corresponding one of the weighted edges connected to the user node; and
update the values of the weights in accordance with a change in the frequency, the duration or the timing.

16. The apparatus of claim 15, wherein the processor is configured to:
determine a relevance score from the weights; and
assign a presentation priority to the tuning parameters in accordance with the relevance score.

17. The apparatus of claim 16, wherein the processor is further configured to:
decrease the relevance score upon a determination of a reduction in one or more values of the weights.

18. A non-transitory tangible computer-readable medium having encoded thereon instructions that, when executed by a processor, are operable to:
construct a social graph representative of a social network, the social graph including nodes and edges representing activities in the social network;
extract content from communication transactions of a communication network;
modify the social graph in accordance with the extracted content;
determine activity stream tuning parameters for a user of the social network from the modified social graph; and
present activity stream data to the user in accordance with the tuning parameters.

19. The computer-readable medium of claim 18, including processor instructions that, when executed by the processor, are operable to:
identify relationships between the activities conducted through a social network service and other activities determined from the extracted content of the communication transactions outside the social network service;
represent the other activities in the social graph; and
store data representing the social graph.

20. The computer-readable medium of claim 19, including processor instructions that, when executed by the processor, are operable to:
identify semantic elements in the extracted content;
assign the identified semantic elements to additional nodes and edges in the social graph; and
add the additional nodes and edges to the social graph.

21. The computer-readable medium of claim 20, including processor instructions that, when executed by the processor, are operable to:
identify nodes connected to a node in the social graph representing the user;
establish weights on respective edges connecting the nodes to the user node; and
assign values to the weights based on a quality of the respective activities represented by the edges.

22. The computer-readable medium of claim 21, including processor instructions that, when executed by the processor, are operable to:
monitor the activities determine a frequency, duration or timing of an activity represented by a corresponding one of the weighted edges connected to the user node;
update the values of the weights in accordance with a change in the frequency, the duration or the timing.

23. The computer-readable medium of claim 22, including processor instructions that, when executed by the processor, are operable to:
perform background analysis on the clustered nodes, the background analysis being performed independently of the monitoring; and
modify the values assigned to the weights in accordance with the background analysis.

24. The computer-readable medium of claim 23, including processor instructions that, when executed by the processor, are operable to:
determine a relevance score from the weights; and
assign a presentation priority to the tuning parameters in accordance with the relevance score.

25. The computer-readable medium of claim 24, including processor instructions that, when executed by the processor, are operable to:
decrease the relevance score upon a determination of a reduction in one or more values of the weights.
